(19) United States
(12) Patent Application Publication
(10) Pub. No.: US 2026/0353258 A1
(43) Pub. Date: Nov. 5, 2026

(54) AI-NETWORK-FUNCTION-BASED PROCESSING METHOD, AND DEVICE

(71) Applicant: Beijing Xiaomi Mobile Software Co., Ltd., Beijing (CN)

(72) Inventors: Dong CHEN, Beijing (CN); Zhibin HE, Beijing (CN)

(21) Appl. No.: 19/123,684

(22) PCT Filed: Oct. 26, 2022
(86) PCT No.: PCT/CN2022/127787

§ 371 Date: Apr. 23, 2025

(51) Int. Cl. H04W 48/16; H04W 12/06

(52) U.S. Cl. CPC H04W 48/16; H04W 12/06

(57) ABSTRACT

A method for processing based on an artificial intelligence (AI) network function, performed by a core network device, the method including: receiving a subscription request for an AI network function discovery service transmitted by user equipment (UE), wherein the subscription request includes a subscriber permanent identifier (SUPI); performing, according to the SUPI, authentication on whether the UE is capable of subscribing to the AI network function discovery service; and returning response information for the subscription request to the UE according to an authentication result.

### CROSS-REFERENCE TO RELATED APPLICATION

The present application is a U.S. National Stage of International Application No. PCT/CN 2022/127787, filed on Oct. 26, 2022, the contents of all of which are incorporated herein by reference in their entirety for all purposes.

### BACKGROUND OF THE INVENTION

Artificial Intelligence (AI) has become a core technology of the fifth generation (5G) mobile communication technology. With typical application scenarios overlapping by 80% or more, 5G and AI are deeply integrated. In addition, large-scale coverage of a 5G network provides ubiquitous bearing space for the AI. Thus, a huge pain point of lacking carriers and channels for practicing an AI technology is solved, and development and prosperity of an AI industry are greatly promoted.

### SUMMARY OF THE INVENTION

The present disclosure relates to the field of communication technology, and in particular to a method and device for processing based on an artificial intelligence (AI) network function.

A method for processing based on an artificial intelligence (AI) network function is provided according to embodiments in a first aspect of the present disclosure. The method is performed by a core network device and includes: receiving a subscription request, transmitted by user equipment (UE), for an AI network function discovery service, where the subscription request includes a subscriber permanent identifier (SUPI); performing, according to the SUPI, authentication on whether the UE is capable of subscribing to the AI network function discovery service; and returning response information for the subscription request to the UE according to an authentication result.

A method for processing based on an artificial intelligence (AI) network function is provided according to embodiments in a second aspect of the present disclosure. The method is performed by user equipment (UE) and includes: transmitting a subscription request for an AI network function discovery service to a core network device, where the subscription request includes a subscriber permanent identifier (SUPI), so as to perform, by the core network device according to the SUPI, authentication on whether the UE is capable of subscribing to the AI network function discovery service; and receiving response information for the subscription request returned according to an authentication result by the core network device.

A method for processing based on an artificial intelligence (AI) network function is provided according to embodiments in a third aspect of the present disclosure. The method is performed by a core network device and includes: receiving a query request for an AI network function transmitted by user equipment (UE), where the query request includes a subscriber permanent identifier (SUPI); performing, according to the SUPI, authentication on whether the UE is capable of querying the AI network function; and returning response information for the query request to the UE according to an authentication result.

A method for processing based on an artificial intelligence (AI) network function is provided in a fourth aspect of the present disclosure. The method is performed by user equipment (UE) and includes: transmitting a query request for an AI network function to a core network device, where the query request includes a subscriber permanent identifier (SUPI), so as to perform, by the core network device according to the SUPI, authentication on whether the UE is capable of querying the AI network function; and receiving response information for the query request returned by the core network device according to an authentication result.

A device for processing based on an artificial intelligence (AI) network function is provided in a fifth aspect of the present disclosure. The device is applied to a core network device and includes: a first reception module configured to receive a subscription request for an AI network function discovery service transmitted by user equipment (UE), where the subscription request includes a subscriber permanent identifier (SUPI); a first authentication module configured to perform, according to the SUPI, authentication on whether the UE is capable of subscribing to the AI network function discovery service; and a first transmission module configured to return response information for the subscription request to the UE according to an authentication result.

A device for processing based on an artificial intelligence (AI) network function is provided in embodiments in a sixth aspect of the present disclosure. The device is applied to user equipment (UE) and includes: a first transmission module configured to transmit a subscription request for an AI network function discovery service to a core network device, where the subscription request includes a subscriber permanent identifier (SUPI), so as to perform, by the core network device according to the SUPI, authentication on whether the UE is capable of subscribing to the AI network function discovery service; and a first reception module configured to receive response information for the subscription request returned by the core network device according to an authentication result.

A device for processing based on an artificial intelligence (AI) network function is provided in embodiments in a seventh aspect of the present disclosure. The device is applied to a core network device and includes: a second reception module configured to receive a query request for an AI network function transmitted by user equipment (UE), where the query request includes a subscriber permanent identifier (SUPI); a second authentication module configured to perform, according to the SUPI, authentication on whether the UE is capable of querying the AI network function; and a second transmission module configured to return response information for the query request to the UE according to an authentication result.

A device for processing based on an artificial intelligence (AI) network function is provided in embodiments in an eighth aspect of the present disclosure. The device is applied to user equipment (UE) and includes: a second transmission module configured to transmit a query request for an AI network function to a core network device, where the query request includes a subscriber permanent identifier (SUPI), so as to perform, by the core network device according to the SUPI, authentication on whether the UE is capable of querying the AI network function; and a second reception module configured to receive response information for the query request returned by the core network device according to an authentication result.

A system for processing based on an artificial intelligence (AI) network function is provided in embodiments in a ninth aspect of the present disclosure. The system includes a core network device and user equipment (UE). The core network device performs the method in the embodiments in the first aspect of the present disclosure. The UE performs the method in the embodiments in the second aspect of the present disclosure.

A system for processing based on an artificial intelligence (AI) network function is provided in embodiments in a tenth aspect of the present disclosure. The system includes a core network device and user equipment (UE). The core network device performs the method in the embodiments in the third aspect of the present disclosure. The UE performs the method in the embodiments in the fourth aspect of the present disclosure.

A communication device is provided in embodiments in an eleventh aspect of the present disclosure. The communication device includes: a transceiver; a memory; and one or more processors collectively connected to the transceiver and the memory respectively and collectively configured to control the transceiver to receive and transmit a wireless signal and collectively configured to implement the method in the embodiments in the first aspect, the embodiments in the second aspect, the embodiments in the third aspect, or the embodiments in the fourth aspect of the present disclosure by executing computer-executable instructions in the memory.

A non-transitory computer-readable storage medium is provided in embodiments in a twelfth aspect of the present disclosure. The non-transitory computer-readable storage medium stores computer-executable instructions, where the computer-executable instructions, when executed by one or more processors, implement the method in the embodiments in the first aspect, the embodiments in the second aspect, the embodiments in the third aspect, or the embodiments in the fourth aspect of the present disclosure.

### BRIEF DESCRIPTION OF DRAWINGS

The above and/or additional aspects and advantages of the present disclosure will become apparent and readily appreciated from the following description of embodiments in conjunction with the accompanying drawings.

FIG. 1 is a schematic flowchart of a method for processing based on an artificial intelligence (AI) network function according to an embodiment of the present disclosure.

FIG. 2 is a schematic flowchart of a method for processing based on an AI network function according to an embodiment of the present disclosure.

FIG. 3 is a schematic flowchart of a method for processing based on an AI network function according to an embodiment of the present disclosure.

FIG. 4 is a schematic flowchart of a method for processing based on an AI network function according to an embodiment of the present disclosure.

FIG. 5 is a sequence diagram of a system for processing based on an AI network function according to an embodiment of the present disclosure.

FIG. 6 is a schematic flowchart of a method for processing based on an AI network function according to an embodiment of the present disclosure.

FIG. 7 is a schematic flowchart of a method for processing based on an AI network function according to an embodiment of the present disclosure.

FIG. 8 is a schematic flowchart of a method for processing based on an AI network function according to an embodiment of the present disclosure.

FIG. 9 is a schematic flowchart of a method for processing based on an AI network function according to an embodiment of the present disclosure.

FIG. 10 is a sequence diagram of a method for processing based on an AI network function according to an embodiment of the present disclosure.

FIG. 11 is a block diagram of a device for processing based on an AI network function according to an embodiment of the present disclosure.

FIG. 12 is a block diagram of a device for processing based on an AI network function according to an embodiment of the present disclosure.

FIG. 13 is a block diagram of a device for processing based on an AI network function according to an embodiment of the present disclosure.

FIG. 14 is a block diagram of a device for processing based on an AI network function according to an embodiment of the present disclosure.

FIG. 15 is a schematic structural diagram of a communication device according to an embodiment of the present disclosure.

FIG. 16 is a schematic structural diagram of a chip according to an embodiment of the present disclosure.

### DETAILED DESCRIPTION OF THE INVENTION

Embodiments of the present disclosure are described in detail below, and illustratively shown in the accompanying drawings. The same or similar reference numerals denote the same or similar elements or elements having the same or similar functions throughout. The embodiments described below with reference to the accompanying drawings are illustrative and intended to explain the present disclosure, but cannot be interpreted as limiting the present disclosure. It is to be noted that the embodiments of the present disclosure and features in the embodiments can be mutually combined without conflicts.

The terms used in the embodiments of the present disclosure are merely used to describe particular embodiments, rather than limit the embodiments of the present disclosure. The singular forms “a”, “an”, and “the” used in the embodiments of the present disclosure and the appended claims are also intended to include the plural forms, unless clearly stated in the context otherwise. It is to be understood that the term “and/or” used in the disclosure indicates and encompasses one or any or all possible combinations of a plurality of associated items listed.

It is to be understood that the terms first, second, third, etc. may be employed in the embodiments of the present disclosure to describe various information, but does not limit these information. These terms are merely used to distinguish between the same type of information. For example, first information can also be referred to as second information, and similarly, second information can also be referred to as first information, without departing from the scope of the embodiments of the present disclosure. The word “if” as used in the disclosure can be interpreted as “at the time of”, “when”, or “in response to determining”, depending on the context.

For ease of understanding, the terms involved in the embodiments of the present disclosure are described first.

### 1. Artificial Intelligence Data Collection Application Function (AIDCAF)

An AIDCAF network element is added to a core network device. The AIDCAF network element can summarize invocation information and analysis data results of all AI network functions. The invocation information and the analysis data results of all the AI network functions are transmitted to the AIDCAF network element.

### 2. Network Repository Function (NRF)

An NRF network element can be used for registration, management, and state detection of the network function (NF), and achieve automatic management of all the NFs. In a case of being activated, each NF can provide services only after registering with the NRF. Registration information includes an NF type, an address, a service list, etc. In the embodiment, when the AI network function is registered with a core network, new AI NF information is stored in the NRF network element after an authentication and authorization procedure is passed.

### 3. Unified Data Management (UDM)

User subscription data management, user authentication data management, user identification data management, etc. are realized through the UDM.

In each embodiment below, the AIDCAF network element, the NRF network element, and the UDM network element can be network function modules of the core network device.

A current network has employed various automatic means to improve operation and maintenance efficiency in stages of planning, construction, maintenance, and optimization, but an overall autonomous level of the network is not high, and thus there is still huge room for improvement. The 5th generation (5G) uses an architecture of software defined networking (SDN) and network function virtualization (NFV), making the network highly flexible and more complex. A larger number of factors are considered for network resource allocation, transmission path, optimization algorithm design, etc., and more intelligent means is also needed. An AI technology can assist the network in achieving autonomy improvement, cost reduction, and efficiency increase. Because the AI technology is applied to the 5G network relatively late, relevant research is carried out after a 5G architecture is determined. Intelligent network application in the 5G stage is optimized and transformed on the basis of a traditional network architecture, and thus belongs to a plug-in application as a whole. Due to lack of a common AI workflow and a unified technical framework, network AI application scenarios are fragmented, chimney type research and development is caused, network AI functions are simply superimposed on existing network processes, and intelligent cross-domain and cross-layer applications are difficult to collaborate. In the future, it is considered to add the AI as an independent NF to the 5G core network architecture, and to design a complete set of flows for acquiring an AI service and closely coupled to network flows. Thus, reliable and systematic AI service capabilities are provided, and a novel intelligent communication network system based on AI is achieved.

Currently, as for a demand for adding the AI, as an independent NF, to the 5G core network architecture, no processing solution to subscription and query of an AI network function (AI NF) by user equipment (UE) in the core network has been provided yet, and thus service experience of users is affected.

Thus, a method and device for processing based on an AI network function are provided in the embodiment. A processing solution for UE to subscribe to and query an AI network function in a core network is provided. Thus, a terminal user can subscribe to and query the AI network function in the network for on-demand services, and further the user can acquire latest AI network capabilities of the network and have better service experience.

The method and device for processing based on an AI network function provided by the present disclosure are described in detail below with reference to the accompanying drawings.

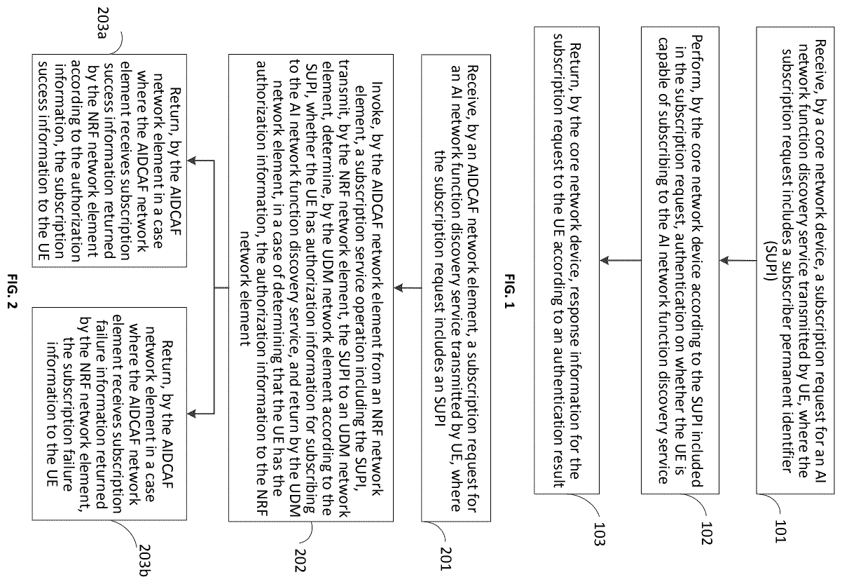

FIG. 1 is a schematic flowchart of a method for processing based on an AI network function according to an embodiment of the present disclosure. The method may be a method for processing subscription to an AI network function by UE in a core network. As shown in FIG. 1, the method is performed by a core network device and may include steps 101, 102 and 103.

In step 101, the core network device receives a subscription request for an AI network function discovery service transmitted by the UE. The subscription request includes a subscriber permanent identifier (SUPI).

In the embodiment, the UE may subscribe to the AI network function discovery service from the core network device. The subscription request transmitted needs to include the SUPI of the UE. The SUPI may be used to determine whether the UE has authorization information for subscribing to the AI network function discovery service. A procedure shown in step 102 may be executed.

In step 102, the core network device performs, according to the SUPI included in the subscription request, authentication on whether the UE is capable of subscribing to the AI network function discovery service.

In step 103, the core network device returns response information for the subscription request to the UE according to an authentication result.

In a case where it is determined through the authentication that the UE has the authorization information for subscribing to the AI network function discovery service, subscription success information may be returned to the UE, and AI network function service information to which the UE subscribes may be transmitted to the UE subsequently. In a case where it is determined through the authentication that the UE has no authorization information for subscribing to the AI network function discovery service, subscription failure information may be returned to the UE.

By the method for processing based on an AI network function according to the embodiment, a processing solution for the UE to subscribe to the AI network function in the core network is provided. Thus, the terminal user can subscribe to the AI network function in the network for on-demand services, and further the user can acquire latest AI network capabilities of the network and have better service experience.

FIG. 2 is a schematic flowchart of a method for processing based on an AI network function according to an embodiment of the present disclosure. The method is performed by a core network device. The core network device may include a first network element. The first network element may be configured to process a subscription request for an AI network function discovery service. In order to illustrate a implementation procedure in the embodiment, based on the embodiment shown in FIG. 1, with the first network element as an AIDCAF network element as an example (it is to be noted that a name of the first network element is not limited in the embodiment and is merely for illustrative description), as shown in FIG. 2, the method may include steps 201, 202, 203a, and 203b.

In step 201, the AIDCAF network element receives a subscription request for an AI network function discovery service transmitted by UE, where the subscription request includes an SUPI.

In the embodiment, the core network device may include the AIDCAF network element, an NRF network element, and a UDM network element. These network elements may be network function modules of the core network device.

In a case of needing to subscribe to the AI network function discovery service from the core network device, the UE may transmit the subscription request for the AI network function discovery service to the AIDCAF network element, where the subscription request may include the SUPI of the UE.

In step 202, the AIDCAF network element invokes from the NRF network element a subscription service operation including the SUPI, the NRF network element transmits the SUPI to the UDM network element, and the UDM network element determines, according to the SUPI, whether the UE has authorization information for subscribing to the AI network function discovery service, and returns, in a case of determining that the UE has the authorization information, the authorization information to the NRF network element.

For example, after receiving the subscription request from the UE, the AIDCAF network element invokes a service operation of Nnrf_NFManagement_NFStatusSubscribe from the NRF network element, and in other words, invokes the subscription service operation including the SUPI included in the subscription request. The NRF network element transmits the SUPI in the subscription request to the UDM network element. The UDM network element confirms whether the UE has authorization for subscribing to the AI network function discovery service from a network, and then returns, in a case of determining that the UE has the authorization information, the authorization information to the NRF network element.

In step 203a, the AIDCAF network element returns, in a case where the AIDCAF network element receives subscription success information returned according to the authorization information by the NRF network element, the subscription success information to the UE.

In a case where the core network device authorizes the UE with this function, the UDM network element confirms that the UE has the authorization for subscribing to the AI network function discovery service from the network, and returns the authorization information to the NRF network element. The NRF network element returns a subscription success notification to the AIDCAF network element according to the authorization information. The AIDCAF network element returns the subscription success notification to the UE. Thus, the subscription to the AI network function discovery service succeeds.

In an example, after the AIDCAF network element returns the subscription success information to the UE, the method may further include: the AIDCAF network element transmitting AI network function service information to which the UE subscribes in the NRF network element to the UE.

For example, after the subscription to the AI network function discovery service succeeds, the NRF network element transmits the Nnrf_NFManagement_NFStatusNotify to the AIDCAF network element in a case where there is an operation conforming to the subscription by the UE in the NRF network element. The AIDCAF network element transmits the subscribed AI network function service information to the UE, and notifies the UE of the subscribed AI network function service information. The UE may passively receive the AI network function service information to which the UE subscribes.

In order to implement directed subscription, the subscription request received by the AIDCAF network element in step 201 may further include at least one of type information (AI NF type) of an AI network function to which the UE is to subscribe, service identity information (AI NF service name) of an AI network function to which the UE is to subscribe, or a public land mobile network identifier (PLMN ID) of the UE, etc.

Correspondingly, the AIDCAF network element transmitting the AI network function service information to which the UE subscribes in the NRF network element to the UE, includes: the AIDCAF network element transmitting AI network function service information, corresponding to at least one of the type information, the service identity information, or the PLMN ID, in the NRF network element, to the UE. In this manner, the directed subscription to the AI network function service information by the UE can be achieved.

In a case where there is a newly-registered AI network function (AI NF), the AI NF updates its configuration information in the NRF network element. Alternatively, in a case where an AI NF cancels its registration in the NRF network element, the NRF network element notifies the AIDCAF network element of corresponding update information. Correspondingly, the AIDCAF network element transmitting the AI network function service information, corresponding to at least one of the type information, the service identity information, or the PLMN ID, in the NRF network element, to the UE includes: the NRF network element transmitting corresponding update information to the AIDCAF network element and the AIDCAF network element transmitting the update information to the UE, in a case where the AI network function service information corresponding to at least one of the type information, the service identity information, or the PLMN ID, in the NRF network element is updated.

For example, after the subscription to the AI network function discovery service succeeds, in a case where the AI network function discovery service to which the UE subscribes undergoes operations such as creation, update, and logout, the NRF network element transmits corresponding update information to the AIDCAF network element, and the AIDCAF network element transmits the update information to the UE. Thus, the UE acquires the corresponding update information in time.

Further, in order to satisfy more use demand, after the subscription to the AI network function discovery service succeeds, in a case of wanting to cancel the subscription, a terminal user at a UE side may further initiate a subscription cancellation request for the AI network function discovery service. Correspondingly, after the AIDCAF network element returns the subscription success information to the UE, the method may further include: the AIDCAF network element receiving a subscription cancellation request for the AI network function discovery service transmitted by the UE, where the subscription cancellation request may include the SUPI of the UE; the AIDCAF network element invoking from the NRF network element a subscription cancellation service operation including the SUPI; the AIDCAF network element returning, according to subscription cancellation success information returned by the NRF network element, the subscription cancellation success information to the UE. Thus, the flow operation of subscription cancellation is completed.

For example, in a case of needing to cancel the subscription to the AI network function discovery service, the UE transmits a subscription cancellation request to the AIDCAF network element. After receiving the subscription cancellation request from the UE, the AIDCAF network element invokes from the NRF network element a service operation of Nnrf_NFManagement_NFStatusUnSubscribe, i.e. a subscription cancellation service operation including the SUPI of the UE. After completing the subscription cancellation request of the UE according to the SUPI, the NRF network element responds to the AIDCAF network element, and the AIDCAF network element returns subscription cancellation success information to the UE.

Step 203b is parallel to step 203a and includes: the AIDCAF network element returning, in a case where the AIDCAF network element receives subscription failure information returned by the NRF network element, the subscription failure information to the UE.

For example, in a case where the core network device does not authorize the UE with this function, the UDM network element confirms that the UE has no authorization for subscribing to the AI network function discovery service from the network, and returns a confirmation result to the NRF network element. The NRF network element returns a subscription failure notification to the AIDCAF network element according to the confirmation result. The AIDCAF network element returns the subscription failure notification to the UE. Thus, the subscription to the AI network function discovery service fails.

By the method for processing based on an AI network function according to the embodiment, a processing solution for the UE to subscribe to the AI network function in the core network is provided. Thus, the terminal user can subscribe to the AI network function in the network for on-demand services, and further the user can acquire latest AI network capabilities of the network and have better service experience.

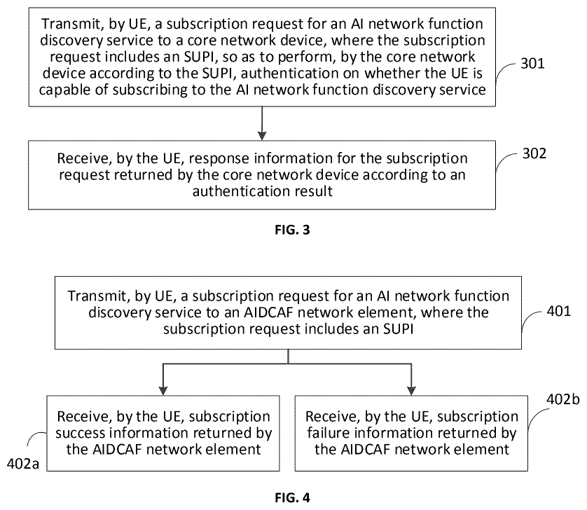

FIG. 3 is a schematic flowchart of a method for processing based on an AI network function according to an embodiment of the present disclosure. The method is performed by UE. As shown in FIG. 3, the method may include steps 301 and 302.

In step 301, the UE transmits a subscription request for an AI network function discovery service to a core network device. The subscription request includes an SUPI, so as to perform, by the core network device according to the SUPI, authentication on whether the UE is capable of subscribing to the AI network function discovery service.

In the embodiment, the UE may subscribe to the AI network function discovery service from the core network device. The subscription request transmitted needs to include the SUPI of the UE. The SUPI may be used to determine whether the UE has authorization information for subscribing to the AI network function discovery service. Reference can be made to the contents in the embodiments shown in FIGS. 1 and 2 for an execution procedure of the core network device, which will not be repeated.

In step 302, the UE receives response information for the subscription request returned by the core network device according to an authentication result.

In a case where it is determined through the authentication that the UE has the authorization information for subscribing to the AI network function discovery service, the UE may receive subscription success information returned by the core network device, and receive AI network function service information to which the UE subscribes subsequently. In a case where it is determined through the authentication that the UE has no authorization information for subscribing to the AI network function discovery service, the UE may receive subscription failure information returned by the core network device.

It is to be noted that while the embodiment shown in FIG. 3 is described on a UE side, the embodiment can be combined with the embodiments shown in FIGS. 1 and 2.

By the method for processing based on an AI network function according to the embodiment, a processing solution for the UE to subscribe to the AI network function in the core network is provided. Thus, the terminal user can subscribe to the AI network function in the network for on-demand services, and further the user can acquire latest AI network capabilities of the network and have better service experience.

FIG. 4 is a schematic flowchart of a method for processing based on an AI network function according to an embodiment of the present disclosure. The method is performed by UE. A core network device may include a first network element. The first network element may be configured to process a subscription request for an AI network function discovery service. In order to illustrate a implementation procedure in the embodiment, based on the embodiment shown in FIG. 3, with the first network element as an AIDCAF network element as an example (it is to be noted that a name of the first network element is not limited in the embodiment and is merely for illustrative description), as shown in FIG. 4, the method may include steps 401, 402a, and 402b.

In step 401, the UE transmits a subscription request for an AI network function discovery service to the AIDCAF network element. The subscription request includes an SUPI.

In the embodiment, the core network device may include the AIDCAF network element. The AIDCAF network element receives the subscription request for the AI network function discovery service from the UE. The subscription request includes the SUPI. The SUPI may be used to determine whether the UE has authorization information for subscribing to the AI network function discovery service, which can make reference to the contents in the embodiment shown in FIG. 2 and will not be repeated.

In step 402a, the UE receives subscription success information returned by the AIDCAF network element.

In a case where the UE receives the subscription success information returned by the AIDCAF network element, it indicates that the UE has subscribes to the AI network function discovery service successfully. After step 402a, the method further includes: the UE receiving AI network function service information, to which the UE subscribes, transmitted by the AIDCAF network element.

In order to implement directed subscription, the subscription request transmitted by the UE in step 401 may further include at least one of type information (AI NF type) of an AI network function to which the UE is to subscribe, service identity information (AI NF service name) of an AI network function to which the UE is to subscribe, or a PLMN ID of the UE, etc. Correspondingly, the UE receiving the AI network function service information, to which the UE subscribes, transmitted by the AIDCAF network element includes: the UE receiving AI network function service information corresponding to at least one of the type information, the service identity information, or the PLMN ID and transmitted by the AIDCAF network element. In this manner, the directed subscription to the AI network function service information by the UE can be achieved.

In a case where the AI network function service information, corresponding to at least one of the type information, the service identity information, or the PLMN ID, in the NRF network element is updated, the NRF network element transmits corresponding update information to the AIDCAF network element, and the AIDCAF network element transmits the update information to the UE. Correspondingly, the UE receiving the AI network function service information corresponding to at least one of the type information, the service identity information, or the PLMN ID and transmitted by the AIDCAF network element may include: the UE receiving update information of the AI network function service information corresponding to at least one of the type information, the service identity information, or the PLMN ID and transmitted by the AIDCAF network element.

For example, after subscription to the AI network function discovery service succeeds, in a case where the AI network function discovery service to which the UE subscribes undergoes operations such as creation, update, and logout, the NRF network element transmits the corresponding update information to the AIDCAF network element, and the AIDCAF network element transmits the update information to the UE. The UE receives these updates transmitted by the AIDCAF network element, so as to acquire the corresponding update information in time.

Further, in order to satisfy more use demand, after the subscription to the AI network function discovery service succeeds, in a case of wanting to cancel the subscription, a terminal user at a UE side may further initiate a subscription cancellation request for the AI network function discovery service. Correspondingly, after the UE receives the subscription success information returned by the AIDCAF network element, the method may further include: the UE transmitting a subscription cancellation request for the AI network function discovery service to the core network device. The AIDCAF network element receives the subscription cancellation request, where the subscription cancellation request may include the SUPI. The UE receives subscription cancellation success information returned by the AIDCAF network element. Thus, the procedure of subscription cancellation is completed.

Step 402b is parallel to step 402a and includes: the UE receiving subscription failure information returned by the AIDCAF network element.

In a case where the UE receives the subscription failure information returned by the AIDCAF network element, it indicates that the subscription to the AI network function discovery service fails, and corresponding prompt information may be output.

It is to be noted that while the embodiment shown in FIG. 4 is described on the UE side, the embodiment can be combined with the embodiments shown in FIGS. 1 and 2.

By the method for processing based on an AI network function according to the embodiment, a processing solution for the UE to subscribe to the AI network function in the core network is provided. Thus, the terminal user can subscribe to the AI network function in the network for on-demand services, and further the user can acquire latest AI network capabilities of the network and have better service experience.

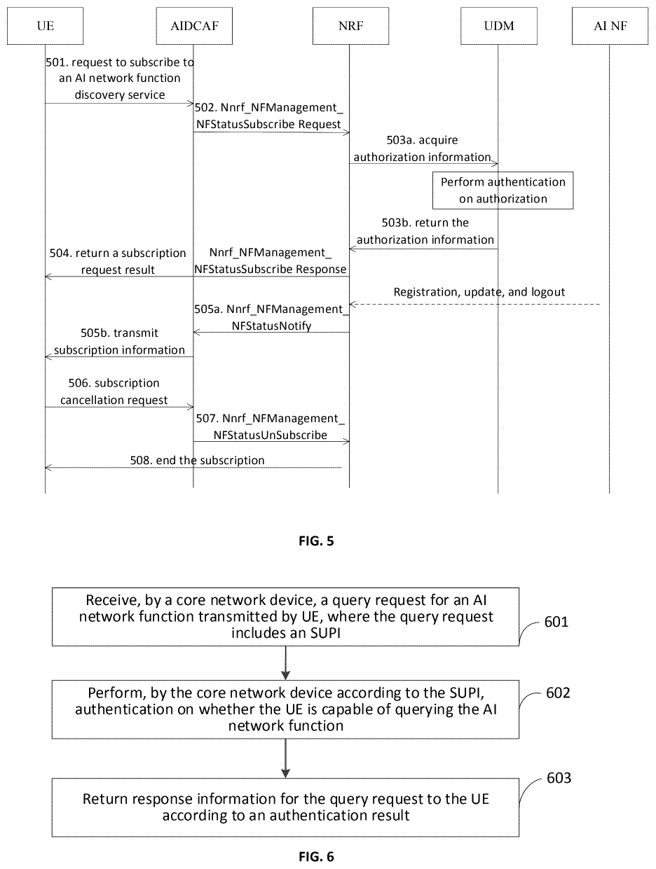

FIG. 5 is a sequence diagram of a method for processing based on an AI network function according to an embodiment of the present disclosure. The method is performed by a system for processing based on an AI network function. The system includes a core network device and UE. The core network device may include an AIDCAF network element, an NRF network element, and a UDM network element.

With reference to FIG. 5, the method includes the following steps.

In step 501, the UE requests to subscribe to an AI network function discovery service from the AIDCAF network element.

The UE subscribes to the AI network function discovery service from the core network device, and transmits subscription request to the AIDCAF network element. The subscription request may include an AI NF type, an SUPI, an AI NF service name, a PLMN ID, etc., and thus directed subscription may be performed.

In step 502, after receiving the subscription request from the UE, the AIDCAF network element invokes from the NRF network element a request service operation of Nnrf_NFManagement_NFStatusSubscribe.

The AIDCAF network element transmits the SUPI in the subscription request to the NRF network element.

In step 503, the NRF network element acquires authorization information from the UDM network element.

The NRF network element transmits the SUPI in the subscription request to the UDM network element. The UDM network element confirms whether the UE has authorization for subscribing to the AI network function discovery service from a network. In a case where the UE has the authorization, authorization information is returned to the NRF network element.

In step 504, the NRF network element returns a request response for the Nnrf_NFManagement_NFStatusSubscribe to the AIDCAF network element, and the AIDCAF network element returns a subscription request result to the UE.

In a case where the core network device does not authorize the UE with this function, the NRF network element returns a subscription failure notification to the AIDCAF network element. The AIDCAF network element transmits the subscription failure notification to the UE. Thus, the subscription to the AI network function discovery service fails. In a case where the core network device authorizes the UE with this function, the NRF network element returns a subscription success notification to the AIDCAF network element. The AIDCAF network element returns the subscription success notification to the UE. Thus, the subscription to the AI network function discovery service succeeds.

In step 505, after the UE subscribes to the AI network function discovery service successfully, in a case where there is an operation conforming to the subscription by the UE in the NRF network element, Nnrf_NFManagement_NFStatusNotify is transmitted to the AIDCAF network element, and the AIDCAF network element transmits subscribed information to the UE, and notifies the UE of the subscribed information.

In a case where there is a newly-registered AI NF, an AI NF updates its configuration information in the NRF network element, or an AI NF cancels its registration in the NRF network element, the NRF network element notifies the AIDCAF network element of update information.

In step 506, in a case of needing to cancel the subscription to the AI network function discovery service, the UE transmits a subscription cancellation request to the AIDCAF network element.

In step 507, after receiving the subscription cancellation request from the UE, the AIDCAF network element invokes from the NRF network element a service operation of Nnrf_NFManagement_NFStatusUnSubscribe.

In step 508, after completing the subscription cancellation request of the UE, the NRF network element transmits a subscription cancellation response to the AIDCAF network element, and the AIDCAF network element returns the subscription cancellation response to the UE.

By the method for processing based on an AI network function according to the embodiment, a processing solution for the UE to subscribe to the AI network function in the core network is provided. Thus, the terminal user can subscribe to the AI network function in the network for on-demand services, and further the user can acquire latest AI network capabilities of the network and have better service experience.

FIG. 6 is a schematic flowchart of a method for processing based on an AI network function according to an embodiment of the present disclosure. The method may be a method for processing a query about an AI network function by UE in a core network. As shown in FIG. 6, the method is performed by a core network device and may include steps 601, 602, and 603.

In step 601, the core network device receives a query request for an AI network function transmitted by UE. The query request includes an SUPI.

In the embodiment, the UE may query the AI network function from the core network device. The query request transmitted needs to include the SUPI of the UE. The SUPI may be used to determine whether the UE has authorization information for querying the AI network function. A procedure shown in step 602 may be performed.

In step 602, the core network device performs, according to the SUPI, authentication on whether the UE is capable of querying the AI network function.

In step 603, response information for the query request is returned to the UE according to an authentication result.

In a case where it is determined through the authentication that the UE has the authorization information for querying the AI network function, corresponding query result information may be returned to the UE. In a case where it is determined through the authentication that the UE has no authorization information for querying the AI network function, query failure information may be returned to the UE.

It is to be noted that while the embodiment shown in FIG. 6 is a method for processing a query about an AI network function by UE in a core network, the embodiment can be combined with the method for processing subscription in the embodiments shown in FIGS. 1-5, so as to further implement a processing procedure for the UE to subscribe to and query the AI network function in the core network.

By the method for processing based on an AI network function according to the embodiment, a processing solution for the UE to query the AI network function in the core network is provided. Thus, the terminal user can query the AI network function in the network for on-demand services, and further the user can acquire latest AI network capabilities of the network and have better service experience.

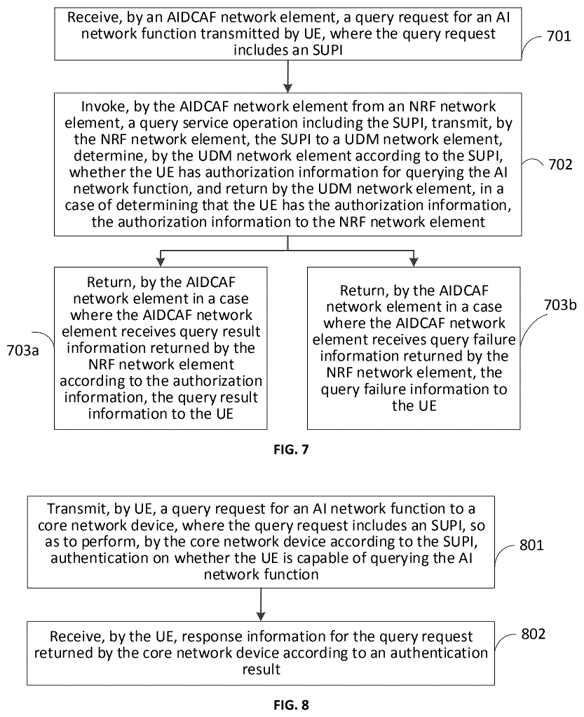

FIG. 7 is a schematic flowchart of a method for processing based on an AI network function according to an embodiment of the present disclosure. The method is performed by a core network device. The core network device may include a second network element. The second network element may be configured to process a query request for the AI network function. In order to illustrate a implementation procedure in the embodiment, based on the embodiment shown in FIG. 6, with the second network element as an AIDCAF network element as an example (it is to be noted that a name of the second network element is not limited in the embodiment and is merely for illustrative description), as shown in FIG. 7, the method may include steps 701, 702, 703a, and 703b.

In step 701, the AIDCAF network element receives a query request for an AI network function transmitted by UE. The query request includes an SUPI.

In the embodiment, the core network device may include the AIDCAF network element, an NRF network element, and a UDM network element. These network elements may be network function modules of the core network device.

In a case of needing to query the AI network function from the core network device, the UE may transmit the query request for the AI network function to the AIDCAF network element, where the query request may include the SUPI of the UE.

In step 702, the AIDCAF network element invokes from the NRF network element a query service operation including the SUPI; the NRF network element transmits the SUPI to the UDM network element, and the UDM network element determines, according to the SUPI, whether the UE has authorization information for querying the AI network function, and return, in a case of determining that the UE has the authorization information, the authorization information to the NRF network element.

For example, after receiving the query request from the UE, the AIDCAF network element invokes from the NRF network element a service operation of Nnrf_NFDiscovery_Request, and in other words, invokes a query service operation including the SUPI included in the query request. The NRF network element transmits the SUPI in the query request to the UDM network element. The UDM network element confirms whether the UE has authorization for querying the AI network function from a network, and then returns, in a case of determining that the UE has the authorization information, the authorization information to the NRF network element.

In step 703a, the AIDCAF network element returns, in a case where the AIDCAF network element receives query result information returned according to the authorization information by the NRF network element, the query result information to the UE.

In a case where the core network device authorizes the UE with this function, the UDM network element confirms that the UE has the authorization for querying the AI network function from the core network, and returns the authorization information to the NRF network element. The NRF network element returns the query result information, such as matched AI network function service information searched for according to the query request, to the AIDCAF network element according to the authorization information. The AIDCAF network element returns the query result information to the UE, so that the UE queries the AI network function service information required.

In order to implement a directed query, the query request received by the AIDCAF network element in step 701 may further include at least one of type information (AI NF type) of an AI network function to be queried by the UE, service identity information (AI NF service name) of an AI network function to be queried by the UE, or a PLMN ID of the UE, etc.

Correspondingly, the AIDCAF network element returning the query result information to the UE may include: the AIDCAF network element transmitting AI network function service information, corresponding to at least one of the type information, the service identity information, or the PLMN ID, in the NRF network element, to the UE. In this manner, the directed query about the AI network function service information by the UE can be achieved.

Step 703b is parallel to step 703a and includes: the AIDCAF network element returning, in a case where the AIDCAF network element receives query failure information returned by the NRF network element, the query failure information to the UE.

For example, in a case where the core network device does not authorizes the UE with this function, the UDM network element confirms that the UE has no authorization for querying the AI network function from the core network, and returns a confirmation result to the NRF network element. The NRF network element returns the query failure information to the AIDCAF network element according to the confirmation result. The AIDCAF network element returns the query failure information to the UE. Thus, the query about the AI network function by the UE fails.

It is to be noted that while the embodiment shown in FIG. 7 is a method for processing a query about an AI network function by the UE in the core network, the embodiment can be combined with the method for processing subscription in the embodiments shown in FIGS. 1-5, so as to further implement a processing procedure for the UE to subscribe to and query the AI network function in the core network.

By the method for processing based on an AI network function according to the embodiment, a processing solution for the UE to query the AI network function in the core network is provided. Thus, the terminal user can query the AI network function in the network for on-demand services, and further the user can acquire latest AI network capabilities of the network and have better service experience.

FIG. 8 is a schematic flowchart of a method for processing based on an AI network function according to an embodiment of the present disclosure. The method is performed by UE. As shown in FIG. 8, the method may include steps 801 and 802.

In step 801, the UE transmits a query request for an AI network function to a core network device. The query request includes an SUPI, so as to perform, by the core network device according to the SUPI, authentication on whether the UE is capable of querying the AI network function.

In the embodiment, the UE may query the AI network function from the core network device. The query request transmitted needs to include the SUPI of the UE. The SUPI may be used to determine whether the UE has authorization information for querying the AI network function. Reference can be made to the contents in the embodiments shown in FIGS. 6 and 7 for an execution procedure of the core network device, which will not be repeated.

In step 802, the UE receives response information for the query request returned according to an authentication result by the core network device.

In a case where it is determined through the authentication that the UE has the authorization information for querying the AI network function, the UE may receive query result information returned by the core network device. In a case where it is determined through the authentication that the UE has no authorization information for querying the AI network function, the UE may receive query failure information returned by the core network device.

It is to be noted that while the embodiment shown in FIG. 8 is described on a UE side, the embodiment can be combined with the embodiments shown in FIGS. 6 and 7.

By the method for processing based on an AI network function according to the embodiment, a processing solution for the UE to query the AI network function in the core network is provided. Thus, the terminal user can query the AI network function in the network for on-demand services, and further the user can acquire latest AI network capabilities of the network and have better service experience.

FIG. 9 is a schematic flowchart of a method for processing based on an AI network function according to an embodiment of the present disclosure. The method is performed by UE. A core network device may include a second network element. The second network element may be configured to process a query request for an AI network function. In order to illustrate a implementation procedure in the embodiment, based on the embodiment shown in FIG. 8, with the second network element as an AIDCAF network element as an example (it is to be noted that a name of the second network element is not limited in the embodiment and is merely for illustrative description), as shown in FIG. 9, the method may include steps 901, 902a, and 902b.

In step 901, the UE transmits a query request for the AI network function to an AIDCAF network element. The query request includes an SUPI.

In the embodiment, the core network device may include the AIDCAF network element. The AIDCAF network element receives the query request for the AI network function from the UE. The query request includes the SUPI. The SUPI may be used to determine whether the UE has authorization information for querying the AI network function, which can make reference to the contents in the embodiment shown in FIG. 7 and will not be repeated.

In step 902a, the UE receives query result information returned by the AIDCAF network element.

In a case where the UE receives the query result information returned by the AIDCAF network element, it indicates that a query about AI network function service information succeeds.

In order to implement a directed query, the query request transmitted by the UE in step 901 may further include at least one of type information (AI NF type) of an AI network function to be queried by the UE, service identity information (AI NF service name) of an AI network function to be queried by the UE, or a PLMN ID of the UE, etc. Correspondingly, the UE receiving the query result information returned by the AIDCAF network element includes: the UE receiving AI network function service information corresponding to at least one of the type information, the service identity information, or the PLMN ID and transmitted by the AIDCAF network element. In this manner, the directed query about the AI network function service information by the UE can be achieved.

Step 902b is parallel to step 902a and includes: the UE receiving query failure information returned by the AIDCAF network element.

In a case where the UE receives the query failure information returned by the AIDCAF network element, it indicates that the query about the AI network function service information fails, and corresponding prompt information may be output.

It is to be noted that while the embodiment shown in FIG. 9 is described on a UE side, the embodiment can be combined with the embodiments shown in FIGS. 6 and 7.

By the method for processing based on an AI network function according to the embodiment, a processing solution for the UE to query the AI network function in the core network is provided. Thus, the terminal user can query the AI network function in the network for on-demand services, and further the user can acquire latest AI network capabilities of the network and have better service experience.

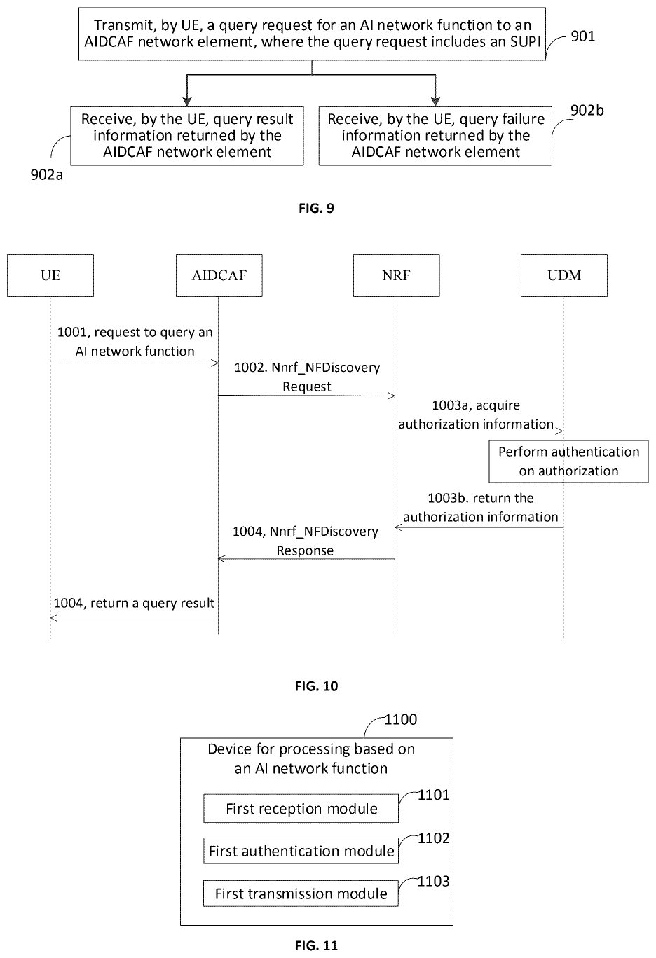

FIG. 10 is a sequence diagram of a method for processing based on an AI network function according to an embodiment of the present disclosure. The method is performed by a system for processing based on an AI network function. The system includes a core network device and UE. The core network device may include an AIDCAF network element, an NRF network element, and a UDM network element.

With reference to FIG. 10, the method includes the following steps.

In step 1001, the UE requests to query an AI network function from the AIDCAF network element.

The UE queries the AI network function from the core network device, and transmits the query request to the AIDCAF network element. The query request may include an AI NF type, an SUPI, an AI NF service name, an PLMN ID, etc., and thus a directed query is performed.

In step 1002, after receiving the query request from the UE, the AIDCAF network element invokes from the NRF network element a request service operation of Nnrf_NFDiscovery_Request.

The AIDCAF network element transmits the SUPI in the query request to the NRF network element.

In step 1003, the NRF network element acquires authorization information from the UDM network element.

The NRF network element transmits the SUPI in the query request to the UDM network element. The UDM network element confirms whether the UE has authorization for querying the AI network function from the core network device, and returns, in a case where the UE has the authorization, the authorization information to the NRF network element.

In step 1004, the NRF network element returns a request response to Nnrf_NFDiscovery_Request to the AIDCAF network element, and the AIDCAF network element returns a query request result to the UE.

In a case where the core network device does not authorize the UE with this function, the NRF network element returns a query failure notification to the AIDCAF network element. The AIDCAF network element transmits the query failure notification to the UE. Thus, the query about the AI network function fails. In a case where the core network device authorizes the UE with this function, the NRF network element searches for matched AI network function service information according to the query request (the AI NF type, the AI NF service name, the PLMN ID, etc.), and transmits a search result to the AIDCAF network element after the search is completed. The AIDCAF network element transmits the search result to the UE. Thus, the query about the AI network function succeeds.

By the method for processing based on an AI network function according to the embodiment, a processing solution for the UE to query the AI network function in the core network is provided. Thus, the terminal user can query the AI network function in the network for on-demand services, and further the user can acquire latest AI network capabilities of the network and have better service experience.

In the above embodiments provided by the present disclosure, the methods according to the embodiments of the present disclosure are described from the perspectives of the core network device and the user equipment respectively. In order to implement all functions in the methods according to the embodiments of the present disclosure, the core network device and the user equipment may each include a hardware structure and a software module, and implement all the functions in a form of the hardware structure, the software module, or the hardware structure plus the software module. One of all the functions may be executed in a form of the hardware structure, the software module, or the hardware structure plus the software module.

The present disclosure further provides a device for processing based on an AI network function, which corresponds to the method for processing based on an AI network function according to several embodiments in the disclosure. Since the device for processing based on an AI network function according to the embodiments of the present disclosure corresponds to the method for processing based on an AI network function according to several embodiments in the disclosure, implementations of the method for processing based on an AI network function is also applicable to the device for processing based on an AI network function according to the embodiment and are not described in detail in the embodiment.

FIG. 11 is a schematic structural diagram of a device for processing based on an AI network function according to an embodiment of the present disclosure. The device 1100 for processing based on an AI network function may be used for a core network device.

As shown in FIG. 11, the device 1100 may include: a first reception module 1101 configured to receive a subscription request for an AI network function discovery service transmitted by user equipment (UE), where the subscription request includes an SUPI; a first authentication module 1102 configured to perform, according to the SUPI, authentication on whether the UE is capable of subscribing to the AI network function discovery service; and a first transmission module 1103 configured to return response information for the subscription request to the UE according to an authentication result.

In some embodiments, the core network device includes a first network element (such as an AIDCAF network element), an NRF network element, and a UDM network element. The first network element is configured to process the subscription request for the AI network function discovery service.

The first reception module 1101 is configured to receive, by the first network element, the subscription request transmitted by the UE.

The first authentication module 1102 is configured to invoke, by the first network element from the NRF network element, a subscription service operation including the SUPI; transmit, by the NRF network element, the SUPI to the UDM network element; and determine, by the UDM network element according to the SUPI, whether the UE has authorization information for subscribing to the AI network function discovery service, and return by the UDM network element, in a case of determining that the UE has the authorization information, the authorization information to the NRF network element.

In some embodiments, the first transmission module 1103 is configured to return, by the first network element in a case where the first network element receives subscription success information returned by the NRF network element according to the authorization information, the subscription success information to the UE; and return, by the first network element in a case where the first network element receives subscription failure information returned by the NRF network element, the subscription failure information to the UE.

In some embodiments, the first transmission module 1103 is further configured to, transmit, by the first network element after the first network element returns the subscription success information to the UE, AI network function service information to which the UE subscribes in the NRF network element to the UE.

In some embodiments, the subscription request further includes at least one of:
type information of an AI network function to which the UE is to subscribe;
service identity information of an AI network function to which the UE is to subscribe; or
a PLMN ID of the UE.

In some embodiments, the first transmission module 1103 is configured to transmit, by the first network element, AI network function service information, corresponding to at least one of the type information, the service identity information, or the PLMN ID, in the NRF network element to the UE.

In some embodiments, the first transmission module 1103 is configured to transmit, by the NRF network element in a case where the AI network function service information, corresponding to at least one of the type information, the service identity information, or the PLMN ID, in the NRF network element is updated, corresponding update information to the first network element; and transmit, by the first network element, the update information to the UE.

In some embodiments, the first reception module 1101 is further configured to receive, by the first network element after the first network element returns the subscription success information to the UE, a subscription cancellation request for the AI network function discovery service transmitted by the UE, where the subscription cancellation request includes the SUPI; invoke, by the first network element from the NRF network element, a subscription cancellation service operation including the SUPI; and return, by the first network element according to subscription cancellation success information returned by the NRF network element, the subscription cancellation success information to the UE.

A processing solution for the UE to subscribe to the AI network function in the core network is provided in the embodiment. Thus, the terminal user can subscribe to the AI network function in the network for on-demand services, and further the user can acquire latest AI network capabilities of the network and have better service experience.

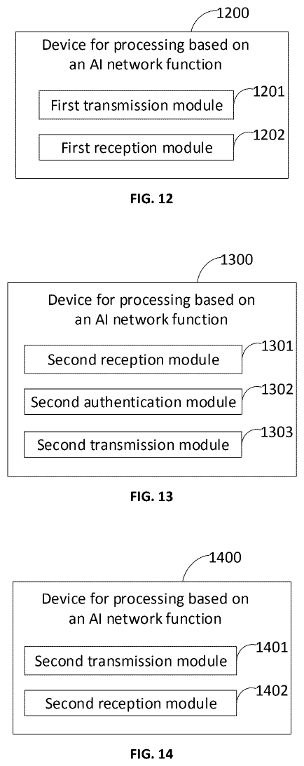

FIG. 12 is a schematic structural diagram of a device for processing based on an AI network function according to an embodiment of the present disclosure. The device 1200 for processing based on an AI network function may be used for UE.

As shown in FIG. 12, the device 1200 may include: a first transmission module 1201 configured to transmit a subscription request for an AI network function discovery service to a core network device, where the subscription request includes an SUPI, so as to perform, by the core network device according to the SUPI, authentication on whether the UE is capable of subscribing to the AI network function discovery service; and a first reception module 1202 configured to receive response information for the subscription request returned by the core network device according to an authentication result.

In some embodiments, the core network device includes a first network element (such as an AIDCAF network element). The first network element is configured to process the subscription request for the AI network function discovery service.

The first reception module 1202 is configured to receive subscription success information returned by the first network element; and alternatively, receive subscription failure information returned by the first network element.

In some embodiments, the first reception module 1202 is further configured to receive, after the subscription success information returned by the first network element is received, AI network function service information to which the UE subscribes and transmitted by the first network element.

In some embodiments, the subscription request further includes at least one of:
type information of an AI network function to which the UE is to subscribe;
service identity information of an AI network function to which the UE is to subscribe; or
a PLMN ID of the UE.

In some embodiments, the first reception module 1202 is configured to receive AI network function service information corresponding to at least one of the type information, the service identity information, or the PLMN ID and transmitted by the first network element.

In some embodiments, the first reception module 1202 is configured to receive update information of the AI network function service information corresponding to at least one of the type information, the service identity information, or the PLMN ID and transmitted by the first network element.

In some embodiments, the first transmission module 1201 is further configured to transmit, after the subscription success information returned by the first network element is received, a subscription cancellation request for the AI network function discovery service to the core network device, where the subscription cancellation request is received by the first network element, and the subscription cancellation request includes the SUPI.

The first reception module 1202 is further configured to receive subscription cancellation success information returned by the first network element.

A processing solution for the UE to subscribe to the AI network function in the core network is provided in the embodiment. Thus, the terminal user can subscribe to the AI network function in the network for on-demand services, and further the user can acquire latest AI network capabilities of the network and have better service experience.

FIG. 13 is a schematic structural diagram of a device for processing based on an AI network function according to an embodiment of the present disclosure. The device 1300 for processing based on an AI network function may be used for a core network device.

As shown in FIG. 13, the device 1300 may include: a second reception module 1301 configured to receive a query request for an AI network function transmitted by user equipment (UE), where the query request includes an SUPI; a second authentication module 1302 configured to perform, according to the SUPI, authentication on whether the UE is capable of querying the AI network function; and a second transmission module 1303 configured to return response information for the query request to the UE according to an authentication result.

In some embodiments, the core network device includes a second network element, an NRF network element, and a UDM network element.

The second reception module 1301 is configured to receive, by the second network element, the query request transmitted by the UE.

The second authentication module 1302 is configured to invoke, by the second network element from the NRF network element, a query service operation including the SUPI; transmit, by the NRF network element, the SUPI to the UDM network element; and determine, by the UDM network element according to the SUPI, whether the UE has authorization information for querying the AI network function, and return by the UDM network element, in a case of determining that the UE has the authorization information, the authorization information to the NRF network element.

In some embodiments, the second transmission module 1303 is configured to return, by the second network element in a case where the second network element receives query result information returned by the NRF network element according to the authorization information, the query result information to the UE; and return, by the second network element in a case where the second network element receives query failure information returned by the NRF network element, the query failure information to the UE.

In some embodiments, the query request further includes at least one of:
type information of an AI network function to be queried by the UE;
service identity information of an AI network function to be queried by the UE; or
a PLMN ID of the UE.

In some embodiments, the second transmission module 1303 is configured to transmit, by the second network element, AI network function service information, corresponding to at least one of the type information, the service identity information, or the PLMN ID, in the NRF network element to the UE.

A processing solution for the UE to query the AI network function in the core network is provided in the embodiment. Thus, the terminal user can query the AI network function in the network for on-demand services, and further the user can acquire latest AI network capabilities of the network and have better service experience.

FIG. 14 is a schematic structural diagram of a device for processing based on an AI network function according to an embodiment of the present disclosure. The device 1400 for processing based on an AI network function may be used for UE.

As shown in FIG. 14, the device 1400 may include: a second transmission module 1401 configured to transmit a query request for the AI network function to a core network device, where the query request includes an SUPI, so as to perform, by the core network device according to the SUPI, authentication on whether the UE is capable of querying the AI network function; and a second reception module 1402 configured to receive response information for the query request returned by the core network device according to an authentication result.

In some embodiments, the core network device includes a second network element. The second network element receives the query request.

The second reception module 1402 is configured to receive query result information returned by the second network element; and alternatively, receive query failure information returned by the second network element.

In some embodiments, the query request further includes at least one of:
type information of an AI network function to be queried by the UE;
service identity information of an AI network function to be queried by the UE; or
a PLMN ID of the UE.

In some embodiments, the second reception module 1402 is configured to receive AI network function service information corresponding to at least one of the type information, the service identity information, or the PLMN ID and transmitted by the second network element.

A processing solution for the UE to query the AI network function in the core network is provided in the embodiment. Thus, the terminal user can query the AI network function in the network for on-demand services, and further the user can acquire latest AI network capabilities of the network and have better service experience.

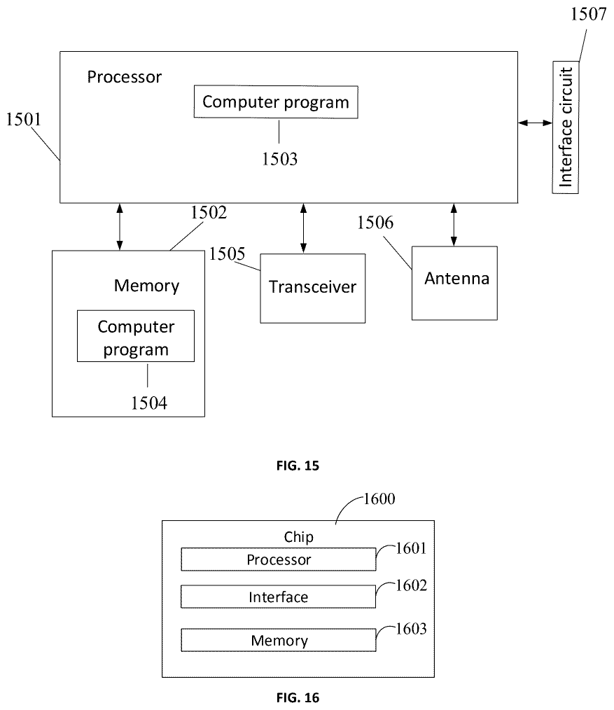

With reference to FIG. 15, FIG. 15 is a schematic structural diagram of a communication device 1500 according to an embodiment. The communication device 1500 can be a network device; user equipment; a chip, a chip system, a processor, etc. that supports the network device in implementing the above-mentioned method; or a chip, a chip system, a processor, etc. that supports the user equipment in implementing the above-mentioned method. The communication device 1500 can be configured to implement the method described in the method embodiment, and reference can be made to the description in the method embodiment for details.

The communication device 1500 can include one or more processors 1501. The processor 1501 can be a general-purpose processor, a special-purpose processor, etc. For example, the processor 1501 can be a baseband processor or a central processing unit. The baseband processor can be configured to process communication protocols and communication data. The central processing unit can be configured to control the communication device 1500 (such as a base station, a baseband chip, a terminal, a terminal chip, a distributed unit (DU), and a centralized unit (CU)), execute a computer program, and process data of the computer program.

In an example, the communication device 1500 can further include one or more memories 1502, where the memory 1502 stores a computer program 1504. The processor 1501 causes the communication device 1500 to perform the method described in the method embodiment by executing the computer program 1504. In an example, the memory 1502 can also store data. The communication device 1500 and the memory 1502 can be arranged separately or integrated together.

In an example, the communication device 1500 can further include a transceiver 1505 and an antenna 1506. The transceiver 1505 can be referred to as a transceiving unit, a transceiving machine, a transceiving circuit, etc., and configured to implement a function of transceiving. The transceiver 1505 can include a receiver and a transmitter. The receiver can be referred to as a reception machine, a reception circuit, etc., and configured to implement a function of reception. The transmitter can be referred to as a transmission machine, a transmission circuit, etc., and configured to implement a function of transmission.

In an example, the communication device 1500 can further include one or more interface circuits 1507. The interface circuit 1507 is configured to receive code instructions, and transmit the code instructions to the processor 1501. The processor 1501 causes the communication device 1500 to perform the method described in the method embodiment by running the code instructions.

In an implementation, the processor 1501 can include a transceiver configured to implement functions of reception and transmission. For example, the transceiver can be a transceiving circuit, an interface, or an interface circuit. The transceiving circuit, interface, or interface circuit configured to implement the functions of reception and transmission can be separated or integrated together. The transceiving circuit, interface, or interface circuit can be configured to read and write codes/data. Alternatively, the transceiving circuit, interface, or interface circuit can be configured to transmit or transfer a signal.

In an implementation, the processor 1501 can store a computer program 1503. The computer program 1503, when running in the processor 1501, can cause the communication device 1500 to perform the method described in the method embodiment. The computer program 1503 may be firmed in the processor 1501. In this case, the processor 1501 may be implemented by hardware.

In an implementation, the communication device 1500 can include a circuit, where the circuit can implement the function of transmission, reception, or communication in the method embodiment. The processor and the transceiver described in the present disclosure can be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver can be fabricated through various IC process technologies, such as a complementary metal oxide semiconductor (CMOS), an nmetal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication device 1500 described in the embodiment can be a network device or user equipment, which is not intended to limit the scope of the communication device 1500 described in the present disclosure. The structure of the communication device 1500 may not be limited by FIG. 15. The communication device 1500 can be a stand-alone device or a part of a large device. For example, the communication device 1500 can be:
(1) an independent integrated circuit (IC), a chip, a chip system, or a chip sub-system;
(2) a set having one or more ICs, which can include a storage component configured to store data and computer programs;
(3) an ASIC, such as a modem;
(4) a module, which can be embedded in other devices;
(5) a receiver, a terminal, a smart terminal, a cellular phone, a radio device, a handset, a mobile unit, a vehicle-mounted device, a network device, a cloud device, an artificial intelligence device, etc. ; and
(6) other device, etc.

Reference can be made to the schematic structural diagram of a chip shown in FIG. 16 for the case where the communication device can be a chip or a chip system. The chip 1600 shown in FIG. 16 includes a processor 1601 and an interface 1602. One or more processors 1601 can be provided, and a plurality of interfaces 1602 can be provided.

In an example, the chip 1600 further includes a memory 1603. The memory 1603 is configured to store necessary computer program and data.

Those skilled in the art can also appreciate that various illustrative logical blocks and steps set forth in the embodiments of the present disclosure can be implemented through electronic hardware, computer software, or their combinations. Whether such functions are implemented through the hardware or the software depends on particular application and overall system design requirements. Those skilled in the art can implement the functions through various methods for each particular application, but such an implementation does not be interpreted as falling beyond the scope of protection of the embodiments of the present disclosure.

The present disclosure further provides a non-transitory computer-readable storage medium. The non-transitory computer-readable storage medium stores instructions. The instructions, when being executed by a computer, implement the functions in any method embodiment.

The present disclosure further provides a computer program product. The computer program product, when being executed by a computer, implements the functions in any method embodiment.

In the embodiment of the present disclosure, some or all of the functions can be implemented through software, hardware, firmware, or their any combinations. When implemented through the software, some or all of the functions can be implemented in a form of the computer program product. The computer program product includes one or more computer programs. When loaded and executed on the computer, some or all of the computer programs generate the flows or functions according to the embodiments of the present disclosure. The computer can be a general-purpose computer, a special-purpose computer, a computer network, or another programmable device. The computer program can be stored in a non-transitory computer-readable storage medium, or transmitted from one non-transitory computer-readable storage medium to another non-transitory computer-readable storage medium, for example, from one website, computer, server, or data center to another website, computer, server, or data center through a wired means (for example, a coaxial cable, an optical fiber, and a digital subscribe line (DSL)), or a wireless means (for example, infrared, radio waves, and microwaves). The non-transitory computer-readable storage medium can be any available medium that the computer can access, or an integrated server, data center, etc. including one or more available media. The available medium can be a magnetic medium (for example, a floppy disk, a hard disk, and a tape), an optical medium (for example, a digital video disk (DVD)), a semiconductor medium (for example, a solid state disk (SSD)), etc.

Those of ordinary skill in the art can understand that various numerical numbers such as first and second involved in the present disclosure are merely for convenience of description, instead of limiting the scope of the embodiments of the present disclosure, and also indicate a successive sequence.

The term “at least one” in the present disclosure can also be described as one or more, and the term “a plurality of” can indicate two, three, four, or more, which is not limited in the present disclosure. In the embodiments of the present disclosure, technical features in a kind of technical features are distinguished by “first”, “second”, “third”, “A”, “B”, “C”, and “D”, and there is no successive sequence or magnitude sequence among the technical features described by “first”, “second”, “third”, “A”, “B”, “C”, and “D”.

As used in the disclosure, the terms “machine-readable medium” and “computer-readable medium” indicate any computer program product, device, and/or apparatus (for example, a magnetic disk, an optical disk, a memory, and a programmable logic device (PLD)) configured to provide machine instructions and/or data for the programmable processor, including a machine-readable medium that receives machine instructions as machine-readable signals. The term “machine-readable signal” indicates any signal configured to provide machine instructions and/or data for the programmable processor.

The system and technology described in the disclosure can be implemented on a computation system (for example, as a data server) that includes a background component, a computation system (for example, an application server) that includes a middleware component, a computation system (for example, a user computer having a graphical user interface or a web browser, through which the user can interact with the implementations of the system and technology described in the disclosure) that includes a front-end component, or a computation system that includes any combination of the background component, the middleware component, or the front-end component. The components of the system can be interconnected through digital data communication (for example, a communication network) in any form or via any medium. Instances of the communication network include a local area network (LAN), a wide area network (WAN), and the Internet.

The computer system can include a client and a server. Typically, the client and the server are away from each other and interact mutually through the communication network. The relation between the client and the server is generated through computer programs running on corresponding computers and having a client-server relation with each other.

It is to be understood that various forms of the flows shown in the disclosure can be used, with steps re-ranked, added, or deleted. For example, as long as the desired results of the technical solution in the present disclosure can be implemented, various steps described in the present disclosure can be executed in parallel, in sequence, or in different orders, which is not limited in the disclosure.

In addition, it is to be understood that various embodiments of the present disclosure can be implemented alone or in combination with other embodiments as the solution permits.

Those of ordinary skill in the art can appreciate that the units and algorithm steps in each instance described in combination with the embodiments in the disclosure can be implemented through electronic hardware, or combinations of computer software and electronic hardware. Whether these functions are executed through hardware or software depends on particular application of the technical solution and design constraint conditions. Those skilled in the art can implement the functions described through different methods for each particular application, but such an implementation is not to be deemed as falling beyond the scope of the present disclosure.

Those skilled in the art can clearly understand that for convenience and brevity of description, reference can be made to corresponding procedures in the method embodiments for operation procedures of the system, device, and unit, which will not be repeated.

What are described are merely the implementations of the present disclosure, which is not intended to limit the scope of protection of the present disclosure. Changes or substitutions that can be readily conceived by those skilled in the art within the technical scope disclosed by the present disclosure fall within the scope of protection of the present disclosure. Thus, the scope of protection of the present disclosure is defined by the scope of protection of the claims.

1. A method for processing based on an artificial intelligence (AI) network function, performed by a core network device, the method comprising:
receiving a subscription request for an AI network function discovery service transmitted by user equipment (UE), wherein the subscription request includes a subscriber permanent identifier (SUPI);
performing, according to the SUPI, authentication on whether the UE is capable of subscribing to the AI network function discovery service; and
returning response information for the subscription request to the UE according to an authentication result.

2. The method according to claim 1, wherein the core network device comprises a first network element, a network repository function (NRF) network element, and a unified data management (UDM) network element, and the first network element is configured to process the subscription request for the AI network function discovery service;
wherein receiving the subscription request for the AI network function discovery service transmitted by the UE comprises:
receiving, by the first network element, the subscription request transmitted by the UE; and
wherein performing, according to the SUPI, the authentication on whether the UE is capable of subscribing to the AI network function discovery service comprises:
invoking, by the first network element from the NRF network element, a subscription service operation including the SUPI; transmitting, by the NRF network element, the SUPI to the UDM network element; and determining, by the UDM network element according to the SUPI, whether the UE has authorization information for subscribing to the AI network function discovery service, and returning by the UDM network element, in a case of determining that the UE has the authorization information, the authorization information to the NRF network element.

3. The method according to claim 2, wherein returning the response information for the subscription request to the UE according to the authentication result comprises:
returning, by the first network element in a case where the first network element receives subscription success information returned by the NRF network element according to the authorization information, the subscription success information to the UE; and
returning, by the first network element in a case where the first network element receives subscription failure information returned by the NRF network element, the subscription failure information to the UE.

4. (canceled)

5. The method according to claim 3, wherein the subscription request further includes at least one of the following:
type information of an AI network function to which the UE is to subscribe;
service identity information of an AI network function to which the UE is to subscribe; or
a public land mobile network identifier (PLMN ID) of the UE.

6. The method according to claim 5, wherein after returning, by the first network element, the subscription success information to the UE, the method further comprises:
transmitting, by the first network element, AI network function service information, corresponding to at least one of the type information, the service identity information, or the PLMN ID, in the NRF network element to the UE.

7. (canceled)

8. The method according to claim 3, wherein after returning, by the first network element, the subscription success information to the UE, the method further comprises:
receiving, by the first network element, a subscription cancellation request for the AI network function discovery service transmitted by the UE, wherein the subscription cancellation request includes the SUPI;
invoking, by the first network element from the NRF network element, a subscription cancellation service operation including the SUPI; and
returning, by the first network element according to subscription cancellation success information returned by the NRF network element, the subscription cancellation success information to the UE.

9. A method for processing based on an artificial intelligence (AI) network function, performed by user equipment (UE), the method comprising:
transmitting a subscription request for an AI network function discovery service to a core network device, wherein the subscription request includes a subscriber permanent identifier (SUPI), so as to perform, by the core network device according to the SUPI, authentication on whether the UE is capable of subscribing to the AI network function discovery service; and
receiving response information for the subscription request returned by the core network device according to an authentication result.

10. The method according to claims 9, wherein the core network device comprises a first network element, and the first network element is configured to process the subscription request for the AI network function discovery service; and
receiving the response information for the subscription request returned by the core network device according to the authentication result comprises:
receiving subscription success information returned by the first network element; or
receiving subscription failure information returned by the first network element.

11. (canceled)

12. The method according to claim 10, wherein the subscription request further includes at least one of the following:
type information of an AI network function to which the UE is to subscribe;
service identity information of an AI network function to which the UE is to subscribe; or
a public land mobile network identifier (PLMN ID) of the UE.

13. The method according to claim 12, wherein after receiving the subscription success information returned by the first network element, the method further comprises:
receiving AI network function service information corresponding to at least one of the type information, the service identity information, or the PLMN ID and transmitted by the first network element.

14. (canceled)

15. The method according to claim 10, wherein after receiving the subscription success information returned by the first network element, the method further comprises:
transmitting a subscription cancellation request for the AI network function discovery service to the core network device, wherein the subscription cancellation request is received by the first network element, and the subscription cancellation request includes the SUPI; and
receiving subscription cancellation success information returned by the first network element.

16. A method for processing based on an artificial intelligence (AI) network function, performed by a core network device, the method comprising:
receiving a query request for an AI network function transmitted by user equipment (UE), wherein the query request includes a subscriber permanent identifier (SUPI);
performing, according to the SUPI, authentication on whether the UE is capable of querying the AI network function; and
returning response information for the query request to the UE according to an authentication result.

17. The method according to claim 16, wherein the core network device comprises a second network element, a network repository function (NRF) network element, and a unified data management (UDM) network element, and the second network element is configured to process the query request for the AI network function;
wherein receiving the query request for the AI network function transmitted by the UE comprises:
receiving, by the second network element, the query request transmitted by the UE; and
wherein performing, according to the SUPI, the authentication on whether the UE is capable of querying the AI network function comprises:
invoking, by the second network element from the NRF network element, a query service operation including the SUPI; transmitting, by the NRF network element, the SUPI to the UDM network element; and determining, by the UDM network element according to the SUPI, whether the UE has authorization information for querying the AI network function, and returning by the UDM network element, in a case of determining that the UE has the authorization information, the authorization information to the NRF network element.

18. (canceled)

19. The method according to claim 17, wherein the query request further includes at least one of the following:
type information of an AI network function to be queried by the UE;
service identity information of an AI network function to be queried by the UE; or
a public land mobile network identifier (PLMN ID) of the UE.

20. The method according to claim 19, wherein returning the response information for the query request to the UE according to the authentication result comprises:
transmitting, by the second network element in a case where the second network element receives query result information returned by the NRF network element according to the authorization information, AI network function service information, corresponding to at least one of the type information, the service identity information, or the PLMN ID, in the NRF network element to the UE.

21-29. (canceled)

30. A communication device, comprising: a transceiver; a memory; and
one or more processors collectively connected to the transceiver and the memory respectively and collectively configured to control the transceiver to receive and transmit a wireless signal and perform the method according to claim 1 by executing non-transitory computer-executable instructions stored in the memory.

31. A non-transitory computer-readable storage medium, storing computer-executable instructions, wherein the computer-executable instructions, when collectively executed by one or more processors, cause the one or more processors to perform the method according to claim 1.

32. A communication device, comprising: a transceiver; a memory; and one or more processors collectively connected to the transceiver and the memory respectively and collectively configured to control the transceiver to receive and transmit a wireless signal and perform the method according to claim 9 by executing non-transitory computer-executable instructions stored in the memory.

33. A communication device, comprising: a transceiver; a memory; and one or more processors collectively connected to the transceiver and the memory respectively and collectively configured to control the transceiver to receive and transmit a wireless signal and perform the method according to claim 16 by executing non-transitory computer-executable instructions stored in the memory.

34. A non-transitory computer-readable storage medium, storing computer-executable instructions, wherein the computer-executable instructions, when collectively executed by one or more processors, cause the one or more processors to perform the method according to claim 9.
